(19) United States
(12) Patent Application Publication
(10) Pub. No.: US 2015/0123773 A1
(43) Pub. Date: May 7, 2015

(54) Television Remote Control with Additional Features

(71) Applicant: Jack Markwell, Portland, TN (US)

(72) Inventor: Jack Markwell, Portland, TN (US)

(21) Appl. No.: 14/535,749

(22) Filed: Nov. 7, 2014

Related U.S. Application Data
(60) Provisional application No. 61/901,074, filed on Nov. 7, 2013.

(51) Int. Cl. G08C 17/02

(52) U.S. Cl. CPC G08C 17/02; G08C 2201/11
USPC 340/12.22

(57) ABSTRACT

A television remote control features a rechargeable battery, which may be recharged with either an adapter cord, or a recharging cradle. The remote control also features a simple paging system, which causes a beeper in the remote control to sound off when the paging system is activated.

### CROSS-REFERENCE TO RELATED APPLICATIONS

This application claims the benefit of U.S. Provisional Application No. 61/901,074 filed Nov. 7, 2013, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to home entertainment accessories and in particular to a television remote control with additional features. The television remote control has become ubiquitous in nearly every home in America that has a television set. Two of the most frequent remote control related problems that arise are dead batteries, and the remote control becoming difficult to find. A remote control which addresses these frequent problems would be well received. The remote control features a rechargeable battery, which may be recharged with either an adapter cord, or a recharging cradle. The remote control also features a simple paging system, which causes a beeper in the remote control to sound off when the paging system is activated.

### SUMMARY OF THE INVENTION

Accordingly, the invention is directed to a television remote control with additional features. The remote control features a rechargeable battery, which may be recharged with either an adapter cord, or a recharging cradle. The remote control also features a simple paging system, which causes a beeper in the remote control to sound off when the paging system is activated.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate three embodiments of the invention and, together with the description, serve to explain the principles of the invention.

FIG. 1 shows a front perspective view of the television component of the first exemplary embodiment, displaying the television 10, and the paging button 15.

FIG. 2 shows a front perspective view of the recharging cradle component and the remote control component of the first exemplary embodiment, displaying the remote control 11, the recharging cradle 12, the paging button 15, the internal rechargeable battery 16, and the beeper 17.

FIG. 3 shows a front perspective view of the adapter cord component and the remote control component of the second exemplary embodiment, displaying the remote control 11, the adapter cord 13, the paging button 15, the internal rechargeable battery 16, and the beeper 17.

FIG. 4 shows a front perspective view of the video game console component of the third exemplary embodiment, displaying the remote control 11, the video game console 14, and the paging button 15.

FIG. 5 shows a front perspective view of the cable or satellite converter box component of the fourth exemplary embodiment, displaying the cable or satellite converter box 50 and the paging button 51.

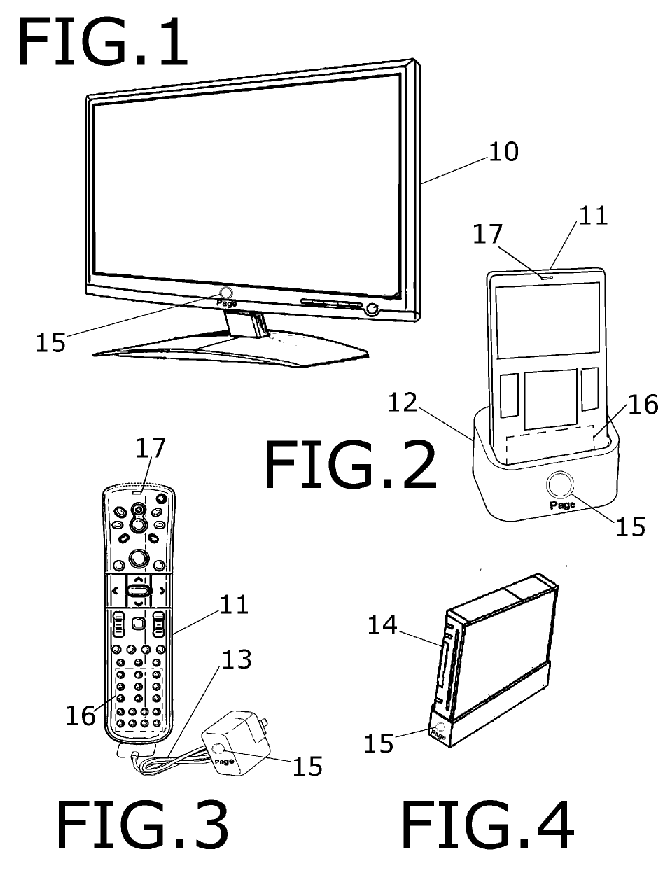

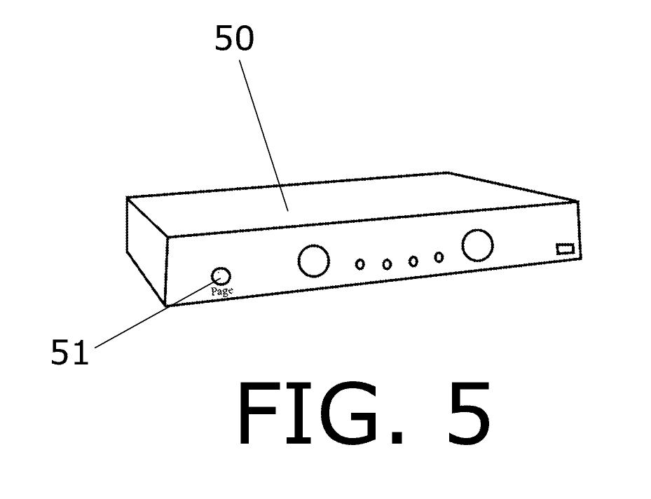

### DETAILED DESCRIPTION OF THE INVENTION

Referring now to the invention in more detail, the invention is directed to a television remote control 11 with additional features. The remote control 11 features an internal rechargeable battery 16, which may be recharged with either an adapter cord 13, or a recharging cradle 12. The remote control 10 also features a simple paging system, which causes a beeper 17 in the remote control 10 to sound off when the paging system is activated.

The invention is intended for installation by manufacturers of televisions, cable television controllers, and video game controllers as original equipment. An alternate embodiment, intended for installation as an after-market modification, is also contemplated.

The first exemplary embodiment comprises three components: a television 10, featuring a paging button 15; a remote control 11; and a recharging cradle 12, also featuring a paging button 15.

The second exemplary embodiment comprises three components: a television 10, featuring a paging button 15; a remote control 11; and an adapter cord 13, also featuring a paging button 15.

The third exemplary embodiment comprises three components: a video game console 14, featuring a paging button 15; a remote control 11; and a recharging cradle 12, also featuring a paging button 15. Alternate embodiments, wherein an adapter cord 13 featuring a paging button 15 may be substituted for the recharging cradle 12, and a cable television controller featuring a paging button 15 may be substituted for the video game console 14, are also contemplated.

The fourth exemplary embodiment comprises a cable or satellite converter box 50 having a paging button 51. The cable or satellite converter box 50 may be paired with a remote control 11, and either a recharging cradle 12 or adapter cord 13.

Additional embodiments are contemplated wherein the remote control is paired with other types of remotely controlled devices having a paging button and recharging cradle or adapter cord. Devices specifically contemplated include stereo systems, video projectors, remote controlled lighting and indoor climate systems, optical disc players, and the like. Generically, such devices are understood as “remotely controlled devices”.

In all four exemplary embodiments, all components which feature a paging button 15 also feature internal radio frequency (RF) transmitters and internal antennas or other wireless communication means, according to means and methods well-known in the prior art. In all three exemplary embodiments, the remote control 11 features an RF receiver, an internal antenna, an internal ammeter, an internal rechargeable battery 16, and a beeper 17. The remote control 11 may also feature a flashing light of a particularly vivid color, such as red. Generically, the beeper 17, light, or other output signal is understood as “output signal devices,” and the response, whether light, sound, or other type of signal may be generically understood as a “response signal”. In general, the remote control 11 and all paging buttons 15 are in electronic communication such that the responsive paging function of the remote control is activated in response to a paging signal broadcast from any paging button 15.

A method of operation of any of the exemplary embodiments comprises the steps of (1) the user presses or activates a paging button 15 on a component featuring a paging button 15 if the remote control 11 has been misplaced; (2) causing a paging signal to be broadcast from the RF transmitter associated with the paging button that was pressed; (3) receiving the paging signal at the RF receiver in the remote control 11; (4) activating the beeper 17, preferably with beeps one second in duration and separated by one second of silence, or an alternative output signal device; (4) deactivating the beeper 17 in response to the user pressing any button on the face of the remote control 11; (5) after a period of time, preferably ten seconds, deactivating the beeper 17. Further, if the power in the internal rechargeable battery 16 of the remote control 11 is below 10 percent of full power, the beeper 17 may be activated and sound off in a different and easily distinguished pattern, preferably with beeps one-half second in duration and separated by nine and one-half seconds of silence. Activating the recharging function of the remote control 11, by plugging an adapter cord 13 into it, or placing it on a recharging cradle 12, deactivates the beeper 17.

The television 10, remote control 11, recharging cradle 12, adapter cord 13, and video game controller 14 are preferably manufactured from rigid, durable materials, such as plastic, steel, aluminum, and acrylic polymers, featuring wiring which is preferably manufactured from copper alloys sheathed in plastic, and electronic components which are preferably manufactured from rigid, durable materials such as plastic, steel, aluminum, silicon, methacrylate, and copper alloys. The beeper 17 is preferably a speaker, for example a piezoelectric speaker configured to emit one or more square wave tones or other simple synthetic sounds. Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A system and method of operation for a remote control comprising:
(a) a remote control;
(b) said remote control being equipped with an output signal device;
(c) said remote control being equipped with a rechargeable battery;
(d) said rechargeable battery being configured so as to be rechargeable via one of the group of an adapter cord or a recharging cradle;
(e) a remotely controlled device;
(f) at least one of the group of said remotely controlled device, said adapter cord, or said recharging cradle being equipped with a paging button;
(g) said paging button being configured so as to broadcast a paging signal;
(h) said remote control being configured so as to receive said paging signal;
(i) said output signal device being configured so as to emit a response signal in response to said paging signal; and
a method of operation of said remote control, the method comprising:
(j) said paging button being active;
(k) broadcasting said paging signal from said paging button;
(l) receiving said paging signal at said remote control;
(m) activating said response signal via said output signal device.

2. The system and method of operation for a remote control of claim 1 wherein said method of operation of said remote control further comprises deactivating said output signal device in response to any button on the face of said remote control being activated.

3. The system and method of operation for a remote control of claim 1 wherein said method of operation of said remote control further comprises: after a period of time, deactivating said output signal device.

4. The system and method of operation for a remote control of claim 1 wherein said output signal device is a beeper.

5. The system and method of operation for a remote control of claim 1 wherein said output signal device is a light.

6. The system and method of operation for a remote control of claim 4 wherein said response signal comprises beeps one second in duration and separated by one second of silence.

7. The system and method of operation for a remote control of claim 1 wherein said method of operation of said remote control further comprises: if the power in said rechargeable battery is below ten percent of full power, activating said output signal device in an easily distinguished pattern.

8. The system and method of operation for a remote control of claim 1 wherein said method of operation of said remote control further comprises: in response to the activation of the recharging function of said remote control, deactivating said output signal device.

9. The system and method of operation for a remote control of claim 1 wherein said remotely controlled device is selected from the group of: a television, a video game console, a cable or satellite converter box, a stereo system, a video projector, a lighting system, an indoor climate system, or and optical disc player.

10. The system and method of operation for a remote control of claim 3 wherein said method of operation of said remote control further comprises deactivating said output signal device in response to any button on the face of said remote control being activated.

11. The system and method of operation for a remote control of claim 10 wherein said output signal device is a beeper.

12. The system and method of operation for a remote control of claim 10 wherein said output signal device is a light.

13. The system and method of operation for a remote control of claim 11 wherein said response signal comprises beeps one second in duration and separated by one second of silence.

14. The system and method of operation for a remote control of claim 13 wherein said method of operation of said remote control further comprises: if the power in said rechargeable battery is below ten percent of full power, activating said output signal device in an easily distinguished pattern.

15. The system and method of operation for a remote control of claim 13 wherein said method of operation of said remote control further comprises: in response to the activation of the recharging function of said remote control, deactivating said output signal device.

16. The system and method of operation for a remote control of claim 13 wherein said remotely controlled device is selected from the group of: a television, a video game console, a cable or satellite converter box, a stereo system, a video projector, a lighting system, an indoor climate system, or and optical disc player.

17. The system and method of operation for a remote control of claim 14 wherein said remotely controlled device is selected from the group of: a television, a video game console, a cable or satellite converter box, a stereo system, a video projector, a lighting system, an indoor climate system, or and optical disc player.

18. The system and method of operation for a remote control of claim 15 wherein said remotely controlled device is selected from the group of: a television, a video game console, a cable or satellite converter box, a stereo system, a video projector, a lighting system, an indoor climate system, or and optical disc player.

19. The system and method of operation for a remote control of claim 17 wherein said method of operation of said remote control further comprises: in response to the activation of the recharging function of said remote control, deactivating said output signal device.
